(19) United States
(12) Patent Application Publication
(10) Pub. No.: US 2016/0304045 A1
(43) Pub. Date: Oct. 20, 2016

(54) RESTRAINT CHARACTERISTICS CONFIGURATION FOR PASSENGER ZONES

(71) Applicant: Ford Global Technologies, LLC, Dearborn, MI (US)

(72) Inventors: Mark A. Cuddihy, New Boston, MI (US); Manoharprasad K. Rao, Novi, MI (US); Agnes S. Kim, Dearborn, MI (US); Kwaku O. Prakah-Asante, Commerce Twp., MI (US)

(21) Appl. No.: 14/689,144

(22) Filed: Apr. 17, 2015

(51) Int. Cl. B60R 21/015; B60R 21/23

(52) U.S. Cl. CPC B60R 21/01512; B60R 21/23; B60R 2021/01286

(57) ABSTRACT

A vehicle includes at least one controller that may be configured to set a parameter for a vehicle zone based on data from an occupant detection sensor associated with the zone. The controller may be configured to respond to a signal from a nomadic device indicative of a profile of an occupant selected from a plurality of potential occupant profiles and an assignment of the occupant to the zone. The controller may be configured to override the parameter of the zone based on the signal. The vehicle may also include an airbag associated with a seat in the vehicle. The at least one controller may be configured to set the airbag to an enabled state based on the parameter, and override the enabled state in response to a signal from a nomadic device indicative of a child profile being assigned to the seat.

### TECHNICAL FIELD

This application is generally related to an application on a mobile device that allows an operator of a vehicle to set characteristics of a passenger zone according to multiple passenger profiles.

### BACKGROUND

Restraint systems include both passive and active restraint systems. Generally, a passive restraint system or a passive safety device, such as an air bag or in some instances an automatic seat belt, is activated automatically to protect a vehicle passenger at the moment of impact when a collision occurs. The passive restraint system does not require an affirmative action on the part of the occupant. An active restraint system requires an affirmative action such as manually inserting a seat belt tab into a seat belt buckle to secure the seat belt.

Portable child seats are frequently used to help ensure the safety of infants and small children when they are passengers in a vehicle. One way to secure the child seats and facilitate attachment to and removal from the vehicle is to use the “LATCH” (Lower Anchors and Tethers for Children) system.

### SUMMARY

A restraint system for a vehicle includes an occupant detection sensor, an airbag associated with a seat in the vehicle, and at least one controller. The controller is configured to set the airbag to an enabled state in response to data from the sensor indicating that a force on the seat is greater than a predetermined force. The controller is configured to respond to a signal from a nomadic device indicating that a child profile is assigned to the seat by overriding the enabled state such that the airbag does not deploy in response to an impact of the vehicle.

A vehicle occupant configuration system includes at least one controller configured to set a parameter for a vehicle zone based on data from an occupant detection sensor associated with the zone. The controller is configured to respond to a signal from a nomadic device indicative of a profile of an occupant being selected from a plurality of potential occupant profiles and an assignment of the occupant to the zone by overriding the parameter of the zone based on the profile.

A method of configuring a restraint system associated with a seat in a vehicle includes setting a parameter associated with the seat based on data from a sensor indicative of a force on the seat, receiving input selecting an occupant profile from a plurality of occupant profiles, receiving input assigning the occupant profile to the seat, and overriding the parameter based on the occupant profile.

### BRIEF DESCRIPTION OF THE DRAWINGS

FIGS. 1A and 1B are an exemplary block topology of a vehicle infotainment system.

FIG. 2 is an exemplary illustration of a nomadic system including a graphical user interface with multiple occupant profiles.

FIG. 3A is an exemplary illustration of a graphical user interface for a mobile device illustrating occupant seating assignment options.

FIG. 3B is an exemplary illustration of a graphical user interface for a mobile device illustrating assigned occupant seating.

FIG. 4 is an exemplary flow diagram of a process that may be executed by a controller in a vehicle system such as a vehicle infotainment system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

This disclosure, among other things, proposes vehicular systems and methods for configuring a restraint system for a vehicle such as a front seat airbag, a rear inflatable belt (RIB) system, a side curtain airbag, and a seat belt tensioner. The systems and configuration also referred to as a vehicle occupant configuration system include a vehicle restraint system (e.g., a front seat airbag, a rear inflatable belt (RIB) system, a side curtain airbag, and a seat belt tensioner), a nomadic device (e.g., a smart phone, tablet, computer, or smart wearable device) and a signal from a nomadic device in which the signal is based on a profile selected from a plurality of profiles on the nomadic device and an assignment of the profile to a seat of a vehicle. The seat belt tensioner includes a ratchet system, a clutch system or other structure that allows movement of the seat belt under some conditions and locks the seat belt position during other conditions. The seat belt tensioner may include an adjustment parameter that controls the amount and timing of force placed on the seat belt to restrain occupants. The vehicle restraint systems typically operate based on a passive occupant detection system (PODS) including a seat frame having a bolt with a strain gauge to measure a force of the seat frame on the bolt, or a bladder in a seat cushion having a sensor to measure a force applied to the seat and bladder. Restraint systems have performance requirements, for example, a requirement may be that a passive restraint system must deploy for a 5^{th} percentile female (i.e., a female that weighs 105 lbs) or that the passive restraint system must not deploy for a child that weighs less than 65 lbs. Due to the variations in occupants and seating conditions, the occupants between 65 lbs. and 105 lbs. may or may not have their airbag activated, and are said to be in the sensor's ‘grey zone’. For example, the force exerted on a seat of a child that weighs 65 lbs when seated in a forward facing booster seat that may weigh an additional 25 lbs and having the addition of weight of heavy winter clothes and a cup full of water may start to approach 95 lbs. This variation in the force associated with the occupant's seated weight is difficult to overcome using a seat based weight sensing system. The grey zone of the airbag activation can be significantly reduced if the vehicle has an accurate measure of the occupant's standing weight.

The vehicular systems may include vehicular sub-systems and distributed functionality occurring in the vehicle. The vehicle systems and sub-systems may communicate with other vehicular modules via a wire-line or wireless communication protocol. The communication protocol may include but is not limited to wire connections such as CAN, LIN, FlexRay, and Ethernet, and wireless connections such as high frequency communication connections (greater than one gigahertz) such as WiFi, and Bluetooth or lower high frequency communication connections (less than one gigahertz) such as RKE. The vehicular sub-system may communicate either directly or indirectly with a wearable device.

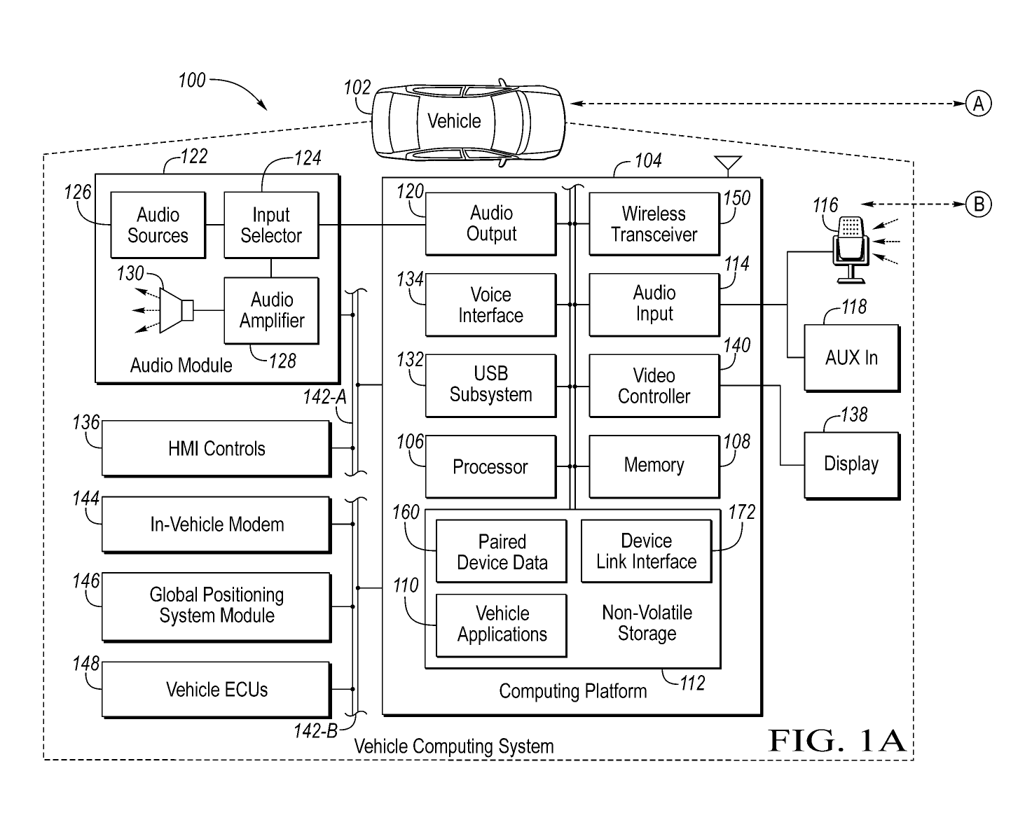

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. The processor may also be multiple processors in multiple computing units which each perform a part of the overall driver alert. For example, one processor may perform audible alert functions, located in the audio module (122), while a different processor in the video controller (140) handles the visual alert, predicated from the same alert message. Computer-executable instructions may be compiled or interpreted from computer programs created using a variety of programming languages and/or technologies, including, without limitation and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142A, and the vehicle modem 144, GPS module 146, and vehicle ECUs 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. The wireless modules may transmit data at a carrier frequency or a center frequency. The center frequency is an important aspect of a wireless system by impacting noise immunity and bandwidth. For example, typical remote keyless entry systems operate at 315 MHz in the United States, and 433 MHz in Europe, while WiFi and Bluetooth may operate at frequencies including frequencies over 2 GHz such as 2.4 GHz. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnect to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features. As exampled in detail below, an appropriate mobile device 152 to display the vehicle component interface application 174 may be identified, and a definition of the user interface to display may be provided to the identified vehicle component interface application 174 for display to the user.

Systems such as the system 100 and system 200 may require mobile device 152 pairing with the computing platform 104 and/or other setup operations. However, as explained in detail below, a system may be configured to allow vehicle occupants to seamlessly interact with user interface elements in their vehicle or with any other framework-enabled vehicle, without requiring the mobile device 152 or wearable device 202 to have been paired with or be in communication with the computing platform 104.

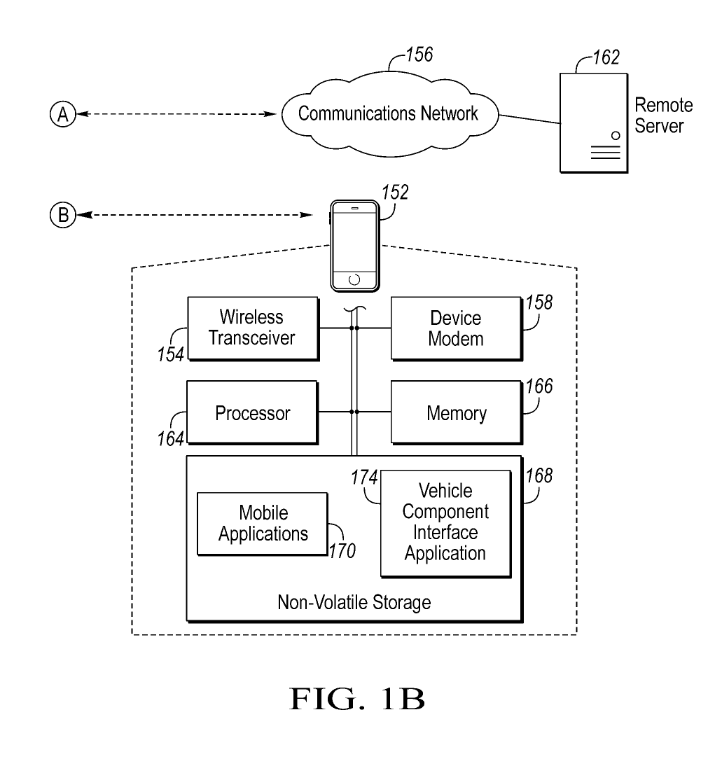

FIG. 2 is an exemplary illustration of a nomadic system 200 including a graphical user interface with multiple occupant profiles. The nomadic system 200 includes a nomadic device 202, such as a smart phone, a smart watch, an electronic tablet, or a computer. The nomadic device 202 includes a controller, also referred to as a processor, configured or programmed to execute software to produce a graphical user interface (GUI) on a display such as a LCD screen, monitor, or other display. The GUI allows profile data 204, such as 204A, 204B and 204C to be entered into, transferred to, stored on, displayed on or output from the nomadic device 202. The profile data 204 may include data associated with multiple potential vehicle occupants. The profile data 204 may include name, age, birthday date, birth year, weight, height, and seating accessories such as booster seat, rear facing car seat, forward facing car seat, or wheelchair accessibility needs. For example, three profiles are shown for three exemplary passengers, Amy's profile 204A, Daniel's profile 204B, and Abigail's profile 204C. Based on Amy's profile 204A, a vehicle will enable airbags. Daniel's profile 204B is such that some airbags must not deploy based on data associated with his weight of 65 lbs. Based on Abigail's profile 204C, she should be assigned to a rear seat if available and some airbags must not deploy.

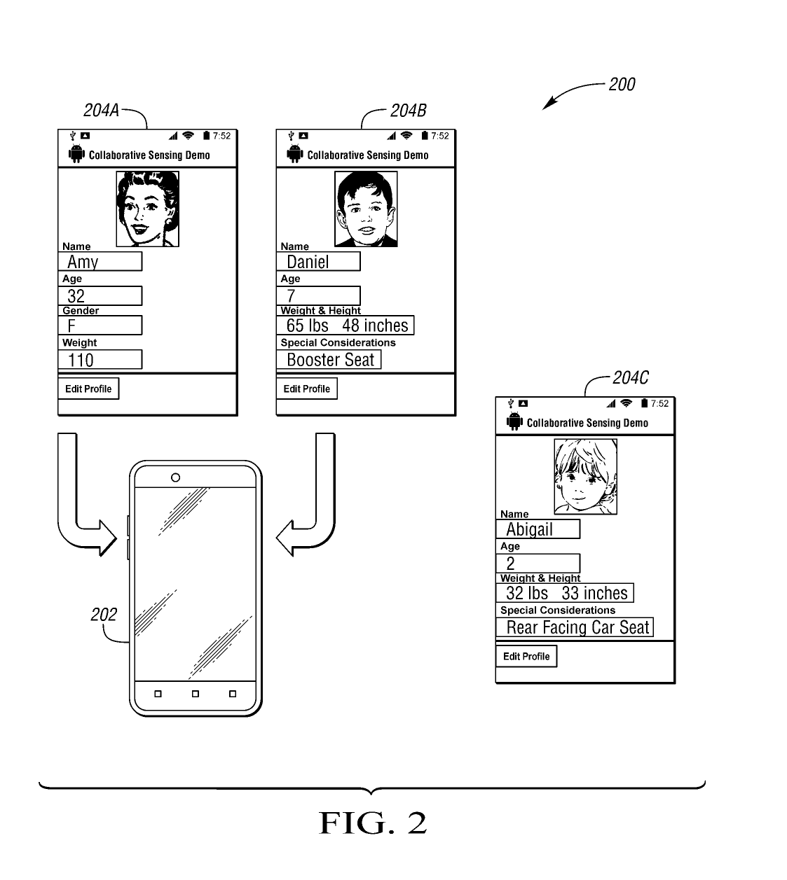

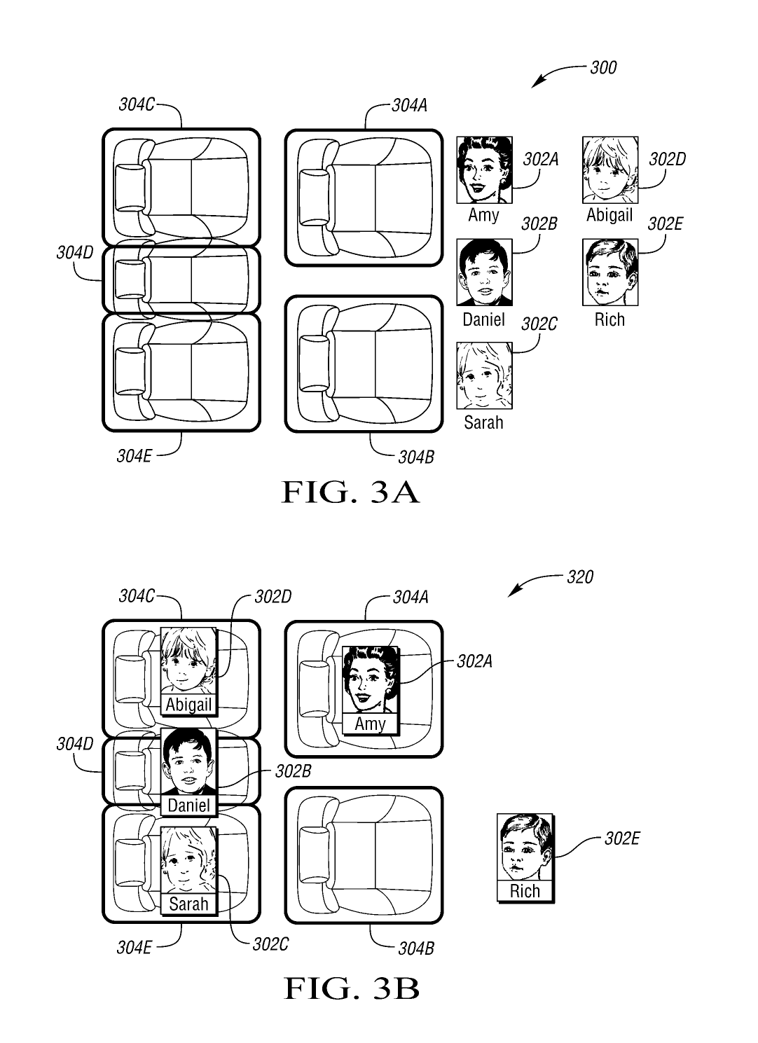

FIG. 3A is an exemplary illustration of a graphical user interface (GUI) for a nomadic device illustrating occupant seating assignment options. A screen shot of the GUI 300 illustrates icons associated with potential occupants 302 having data profiles, such as 302A, 302B and 302C, and available passenger seats 304, such as 304A, 304B, 304C, 304D, and 304E. The passenger seats are each associated with a vehicle zone, which is an area around the seat that includes the seat and an occupant of the seat.

FIG. 3B is an exemplary illustration of a graphical user interface (GUI) for a mobile device illustrating assigned occupant seating. A screen shot of the GUI 320 illustrates an assignment of the potential occupants 302 to available seats 304. In this example, the nomadic device displays icons associated with the occupant profiles 302 in which profiles 302 are assigned by the operator to available seats 304. In this example, the nomadic device is Amy's smart phone and Amy has entered all the data and made the seating assignments. For example, Amy's profile 302A is assigned to the driver seat 304A, Abigail's profile 302D (requiring a rear-facing car seat) is assigned to a seat 304C which is near a door so Abigail can be easily buckled into her car seat. Likewise, Sarah's profile 302C (requiring a forward facing seat) is assigned to seat 304E. Daniel's profile 302B (requiring a booster seat) is assigned to seat 304D. In this example, the family has another child Richard who is a twin of Daniel. Richard's profile 302E is then assigned to the only available seat after the assignment of the other children, seat 304B. Due to weight and age associated with Richard's profile 302E, frontal airbags should not deploy.

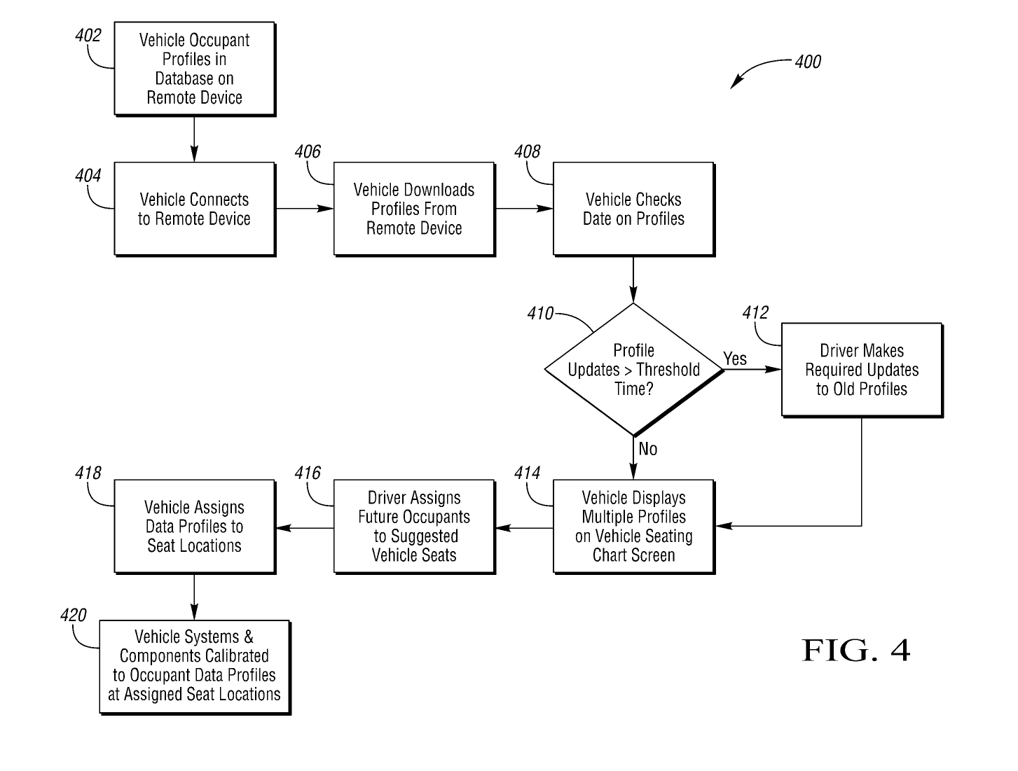

FIG. 4 is an exemplary flow diagram 400 of a process that may be executed by a controller in a vehicle system such as a vehicle infotainment system. This flow diagram 400 illustrates the input of vehicle occupant profiles into a database on a remote or nomadic device in block 402. Next the vehicle connects to the remote or nomadic device in block 404. The vehicle then downloads the profiles from the remote device in block 406. The vehicle checks a date on each profile in block 408 to make sure the data is current. The date of updates to the profile is checked in block 410. If the profile has not been updated within a predetermined timeframe, the GUI will prompt the driver/user to update profiles in block 412. If the date of recent updates is within a threshold window, the GUI will display the profiles on the screen with vehicle seating configuration in block 414. The seating configuration may be a standard seating chart or may be dynamically updated based on seats that are folded down or manually removed. The driver may then assign the occupants to an available seat in block 416. Once the occupants are assigned, the vehicle associates the data profiles to the assigned seats in block 418. The vehicle systems and components associated with the occupant seats are calibrated to associated occupant profiles based on the assignment in block 420. The calibration may include disabling rear belt inflator airbags, or frontal passenger airbags.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A restraint system for a vehicle comprising:
an occupant detection sensor;
an airbag associated with a seat in the vehicle; and
at least one controller configured to
set the airbag to an enabled state in response to data from the sensor indicating that a force on the seat is greater than a predetermined force, and
in response to a signal from a nomadic device indicating that a child profile is assigned to the seat, override the enabled state such that the airbag does not deploy in response to an impact of the vehicle.

2. The system of claim 1, wherein the airbag is a seatbelt airbag.

3. The system of claim 1, wherein the airbag is a passenger front seat airbag.

4. The system of claim 1 further comprising a seat belt tensioner, wherein the at least one controller is further configured to engage the seat belt tensioner at a time based on data from the sensor, an impact of the vehicle, and a delay defined by the profile.

5. The system of claim 1, wherein the signal is a RF signal.

6. The system of claim 5, wherein the RF signal is a WiFi or cellular signal.

7. A vehicle occupant configuration system comprising:
at least one controller configured to set a parameter for a vehicle zone based on data from an occupant detection sensor associated with the zone, and in response to a signal from a nomadic device indicative of a profile of an occupant being selected from a plurality of potential occupant profiles and an assignment of the occupant to the zone, override the parameter of the zone based on the profile.

8. The system of claim 7 further comprising an airbag, wherein the parameter is an airbag enable parameter.

9. The system of claim 8, wherein the airbag is a seatbelt airbag.

10. The system of claim 8, wherein the airbag is a passenger front seat airbag.

11. The system of claim 7 further comprising a two-stage airbag, wherein the parameter defines a delay time for a second stage of the two-stage airbag and wherein the at least one controller is further configured to set the delay time to adjust a stiffness of the airbag based on the profile.

12. The system of claim 7 further comprising a seat belt tensioner, wherein the parameter is a seat belt tensioner adjustment parameter and wherein the at least one controller is further configured to output the seat belt tensioner adjustment parameter at a time defined by data from the sensor indicative of a force in the zone, an impact of the vehicle, and a delay associated with the profile.

13. The system of claim 7, wherein the signal is a RF signal.

14. A method of configuring a restraint system associated with a seat in a vehicle comprising:
setting a parameter associated with the seat based on data from a sensor indicative of a force on the seat;
receiving input selecting an occupant profile from a plurality of occupant profiles;
receiving input assigning the occupant profile to the seat; and
overriding the parameter based on the occupant profile.

15. The method of claim 14, wherein the parameter is an airbag enable parameter.

16. The method of claim 14, wherein the parameter defines a delay time for a second stage of a two-stage airbag, further comprising setting the delay time to adjust a stiffness of the airbag based on the profile.
